(19) United States
(12) Patent Application Publication
(10) Pub. No.: US 2004/0039120 A1
(43) Pub. Date: Feb. 26, 2004

(54) Process for producing a prepreg resin composition

(76) Inventors: Hidekazu Takeyama, Kanagawa Prefecture (JP); Mitsuhiro Iwata, Kanagawa Prefecture (JP); David cha en Tu, Kanagawa Prefecture (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/443,766

(22) Filed: May 23, 2003

(30) Foreign Application Priority Data
May 23, 2002 (JP) 2002-148799

(51) Int. Cl. C08L 63/00

(52) U.S. Cl. 525/107

(57) ABSTRACT

A process for producing a prepreg resin composition includes mixing 100 parts by weight of solid acrylonitrile butadiene rubber with 50 to 400 parts by weight of a solid epoxy resin having a melting point or softening point of 40° C. or higher at a temperature lower than the melting point or softening point of the solid epoxy resin in the absence of a solvent to form a pre-mixture, and mixing the pre-mixture with 500 to 7,000 parts by weight of a liquid epoxy resin having a melting point or softening point of lower than 40° C. and 0.6 to 1.1 equivalents of an aromatic amine-based curing agent based on the epoxy groups which belong to the solid epoxy resin and the liquid epoxy resin. The solid rubber component can be uniformly dispersed in the epoxy resin without using a solvent.

### BACKGROUND OF THE INVENTION

1. Field of the Invention

The present invention relates to a process for producing a prepreg resin composition for use such as a structural material for airplane, automobiles, and the like.

2. Description of the Related Art

A prepreg is a sheet-like molding intermediate material manufactured by impregnating a reinforcing fiber with a matrix resin and is used for such as a structural material for airplanes, automobiles, and the like. An epoxy resin is often used as the matrix resin because it has excellent mechanical properties and heat resistance.

In particular, carbon fiber reinforced plastics have been conventionally used for structural materials for airplanes. The plastics are molded into honeycomb sandwich panel structures to reduce the weight of an airplane in most cases. In this case, such co-curability is required for a prepreg that the curing of the prepreg itself and the adhesion to a honeycomb are carried out at the same time. To provide impact resistance to an obstacle etc during flight, the prepreg must have appropriate toughness. Further, to form a curved surface during the molding of a prepreg, appropriate draping properties are required.

In order to obtain a prepreg which meets the above requirements, it is useful to uniformly disperse 1 to 10 wt % of solid rubber in a low-viscosity epoxy resin. However, since the epoxy resin and the solid rubber greatly differ from each other in their viscosities, shearing stress cannot be applied thereto, which is extremely difficult to mix them together. To mix them together, a solvent is used or the viscosity of the solid rubber is reduced by heating before mixing. It is preferred from the viewpoint of conservation of global environment that the epoxy resin and the solid rubber may be mixed together without using a solvent and from the viewpoint of working efficiency that they can be mixed together under a normal working environment.

JP 5-239317 A discloses an epoxy resin composition which includes an epoxy resin, an aromatic amine-based curing agent and weakly crosslinkable solid acrylonitrile butadiene rubber, and whose complex viscosities measured at different oscillation frequencies meet a fixed relationship.

The above publication teaches that weakly crosslinkable solid acrylonitrile butadiene rubber is mixed at a time using a kneader in order to disperse the solid rubber into an epoxy resin without using a solvent, with the result that the weakly crosslinkable solid acrylonitrile butadiene rubber swells in the epoxy resin and is finely dispersed in the epoxy resin to form a homogeneous resin composition.

However, when rubber having very high compatibility is not used, a long mixing time is needed. Also, there is a case where solid rubber cannot be finely dispersed fully.

### SUMMARY OF THE INVENTION

It is an object of the present invention to provide a process for producing a prepreg resin composition, which can uniformly disperse a small amount of a solid rubber component in an epoxy resin in the absence of a solvent.

According to the present invention, there is provided a process for producing a prepreg resin composition, including: mixing 100 parts by weight of solid acrylonitrile butadiene rubber with 50 to 400 parts by weight of a solid epoxy resin having a melting point or softening point of 40° C. or higher at a temperature lower than the melting point or softening point of the solid epoxy resin in the absence of a solvent to form a pre-mixture; and mixing the pre-mixture with 500 to 7,000 parts by weight of a liquid epoxy resin having a melting point or softening point of lower than 40° C. and 0.6 to 1.1 equivalents of an aromatic amine-based curing agent based on the epoxy groups which belong to the solid epoxy resin and the liquid epoxy resin.

According to the above process for producing a prepreg resin composition, the solid acrylonitrile butadiene rubber is preferably carboxy-modified acrylonitrile butadiene rubber and/or carboxy-modified hydrogenated acrylonitrile butadiene rubber.

Further, the solid epoxy resin is preferably an epoxy resin having at least one functional group selected from the group consisting of a naphthalene ring, a dicyclopentadienyl group, a bisphenyl group and a fluorene group.

Further, the above liquid epoxy resin is preferably an epoxy resin having an N-glycidylamino group.

In addition, the above aromatic amine-based curing agent is preferably an aromatic amine-based compound having two or more amino groups in the molecule.

### DETAILED DESCRIPTION OF THE PREFERRED EMBODIMENTS

The present invention will be described in detail hereinunder.

The process for producing a prepreg resin composition of the present invention includes: mixing 100 parts by weight of solid acrylonitrile butadiene rubber with 50 to 400 parts by weight of a solid epoxy resin having a melting point or softening point of 40° C. or higher at a temperature lower than the melting point or softening point of the solid epoxy resin in the absence of a solvent to form a pre-mixture; and further mixing this pre-mixture with 500 to 7,000 parts by weight of a liquid epoxy resin having a melting point or softening point of lower than 40° C. and 0.6 to 1.1 equivalents of an aromatic amine-based curing agent based on an epoxy group.

According to the present invention, since it is very difficult to mix the liquid epoxy resin with the solid rubber due to a great difference in viscosities between the liquid epoxy resin and the solid rubber, the solid rubber is pre-mixed with an appropriate amount of the solid epoxy resin under shearing stress.

The pre-mixing temperature is lower than the melting point or softening point of the solid epoxy resin, that is, 40° C. or lower. Depending on the type of a mixer, if it takes too long to mix them, the deterioration of rubber or a reaction with the epoxy resin will take place, or water will be easily absorbed. Therefore, it is recommended to set the lower limit temperature to 10° C. Within this range, they can be mixed together under appropriate shearing stress in a short period of time.

Since this can make the viscosity of the pre-mixture lower than the viscosity of the solid acrylonitrile butadiene rubber, the pre-mixture can be easily mixed with the liquid epoxy resin under a normal working atmosphere (20 to 70° C.).

The ratio of the viscosity of the solid epoxy resin to the viscosity of the solid acrylonitrile butadiene rubber is preferably 1 or less at the mixing temperature.

The viscosity at 60° C. of the obtained pre-mixture is preferably adjusted to 10³ to 10⁵ Pa·s according to the blending ratio or the types of the raw materials etc. This is aimed to mix the pre-mixture with the liquid epoxy resin in a shorter period of time.

The amount of the solid epoxy resin is 50 to 400 parts by weight, preferably 50 to 150 parts by weight based on 100 parts by weight of the solid acrylonitrile butadiene rubber.

The mixer to be used for pre-mixing includes a roll, kneader, paint roll, trimixer, continuous mixing roll, and double-screw continuous mixer. The pre-mixture is produced by mixing the solid rubber component with the solid epoxy resin using the above mixer until they are uniformly dispersed in each other.

500 to 7,000 parts by weight of the liquid epoxy resin having a melting point or softening point of lower than 40° C. and 0.6 to 1.1 equivalents of the aromatic amine-based curing agent based on the epoxy group are mixed with the thus obtained pre-mixture.

Although mixing can be carried out under a normal working atmosphere, the mixing time can be shortened by heating. The heating temperature at that time is preferably 50 to 70° C. When the pre-mixture is heated to a temperature equal to or higher than the melting point or softening point of the solid epoxy resin, the viscosity of the pre-mixture sharply drops, thereby making it possible to further reduce the mixing time.

The viscosity at 5° C. of the liquid epoxy resin is preferably 0.5 to 100 Pa·s. Within this range, the desirable draping properties of the prepreg can be obtained. The viscosity is more preferably 5 to 100 Pa·s.

The amount of the liquid epoxy resin is 500 to 7,000 parts by weight based on the above pre-mixture.

The aromatic amine-based curing agent may be added at the same time as the liquid epoxy resin, or before or after the addition of the epoxy resin. By adding the aromatic amine-based curing agent, sufficient heat resistance can be provided as a structural material for airplanes and the like. Since the aromatic amine-based curing agent has a high curing starting temperature, a reinforcing fiber is impregnated with the composition of the present invention containing the curing agent.

The amount of the aromatic amine-based curing agent is 0.6 to 1.1 equivalents based on the epoxy groups which belong to the solid epoxy resin and the liquid epoxy resin.

What are generally used as a curing agent and a curing catalyst for an epoxy resin other than the aromatic amine-based curing agent may also be added in limits that do not impair the object of the present invention. For example, dicyandiamide (DICY), imidazole derivatives, boron trifluoride amine salts, amino benzoates, acid anhydrides, a phenol novolak resin and a cresol novolak resin may be used. The composition of the present invention containing any other curing agent described above does not start curing immediately. Therefore, a reinforcing fiber can be also impregnated with this composition.

The viscosity at 60° C. of the finally obtained prepreg resin composition is preferably adjusted to 10 to 10³ Pa·s according to the amount of the liquid epoxy resin or the like. This is because, within this range, the impregnation of a reinforcing fiber becomes satisfactory.

The glass transition point (Tg) after curing of the obtained prepreg resin composition is preferably adjusted to 170 to 190° C. according to the amount of the liquid epoxy resin or the aromatic amine-based curing agent. This is because, within this range, sufficient heat resistance can be provided as a structural material for airplanes and the like.

The apparatus used for mixing the pre-mixture with the liquid epoxy resin is preferably a mixer which can provide sufficient shearing stress between rubber and epoxy, as exemplified by a trimixer, double-screw mixer, continuous kneader, continuous mixing roll and the like. Since the pre-mixture can be palletized in the present invention, a continuous mixer such as a double-screw mixer, continuous kneader or continuous mixing roll can also be used.

The solid acrylonitrile butadiene rubber is mixed into the epoxy resin by the above mixer until the solid acrylonitrile butadiene is uniformly dispersed in the epoxy resin.

The raw materials used in the present invention will be described hereinunder.

One or both of hydrogenated acrylonitrile butadiene rubber, and non-hydrogenated acrylonitrile butadiene rubber may be used as the solid acrylonitrile butadiene rubber used in the present invention. When hydrogenated acrylonitrile butadiene rubber is used, a prepreg resin composition having excellent weatherability and heat resistance is obtained.

The solid acrylonitrile butadiene rubber preferably has a functional group which can react with an epoxy resin or curing agent, for example, a carboxyl group or an epoxy group. Carboxy-modified acrylonitrile butadiene rubber having a carboxyl group and/or carboxy-modified hydrogenated acrylonitrile butadiene rubber having a carboxyl group are/is particularly preferred. As the carboxy-modified (hydrogenated) acrylonitrile butadiene rubber has excellent compatibility, preferably, the amount of nitrile is 20 to 40 wt % and the amount of carboxyl is 0.5 to 10 wt %.

The above solid acrylonitrile butadiene rubbers may be used alone or in combination of two or more.

The liquid epoxy resin used in the present invention is a compound which contains two or more oxirane rings in one molecule and has a melting point or softening point of lower than 40° C.

Examples of the epoxy resin include: bisphenol A type, bisphenol F type, hydrogenated bisphenol A type, bisphenol AF type, polyalkylene glycol type and alkylene glycol type epoxy compounds; phenol novolak type epoxy resins; glycidyl ester type epoxy resins of a synthetic fatty acid such as dimeric acid; epoxy resins having an N-glycidylamino group such as N,N,N′,N′-tetraglycidyldiaminodiphenylmethane (TGDDM) represented by the following formula (1), tetraglycidyl-m-xylylenediamine, triglycidyl-p-aminophenol and N,N-diglycidylaniline:

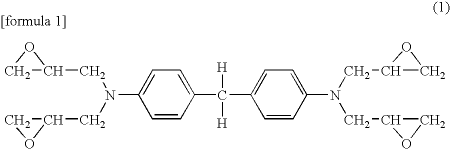

; and epoxy resins represented by the following formula (2):

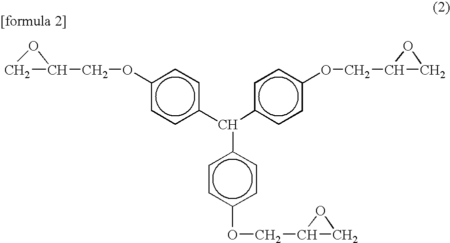

Further, cycloaliphatic epoxy resins, epoxy resins having a sulfur atom in the main chain typified by FREP 10 of Toray Thiocol Co., Ltd.; urethane-modified epoxy resins having an urethane bond; and rubber-modified liquid epoxy resins containing polybutadiene, liquid polyacrylonitrile-butadiene rubber or liquid NBR may also be used.

The above resins may be used alone or in combination of two or more.

Out of these epoxy resins, an epoxy resin having an N-glycidylamino group is preferably contained as an essential component (10 to 70 wt % based on the liquid epoxy resin) because the epoxy resin is particularly excellent in heat resistance and water resistance.

Commercially available products of the epoxy resin having an N-glycidylamino group include ELM®-434 and ELM®-100 of Sumitomo Chemical Co., Ld.

For the purpose of adjusting viscosity, a bisphenol A type epoxy resin such as the Epicoat® 828 (softening point of about 5° C.) of Yuka Shell Epoxy Co., Ltd. is preferably contained.

As the solid epoxy resin used in the present invention may be used a compound which contains two or more oxirane rings in one molecule and has a melting point or softening point of 40° C. or higher, preferably 50° C. or higher, without particular restriction.

For example, brominated bisphenol A type, orthocresol novolak type and bisphenol A type solids may be used for the solid epoxy resin. Commercially available products of an epoxy resin having a dicyclopentadiene group include HP 7200 (softening point of 60° C.) of Dainippon Ink and Chemicals, Inc.

Out of the compounds enumerated as the liquid epoxy resin, compounds each having a high molecular weight and a melting point or softening point of 40° C. or higher, preferably 50° C. or higher may be used alone or in combination of two or more.

It is preferable to use a solid epoxy resin having at least one functional group selected from the group consisting of a naphthalene ring, a dicyclopentadiene group, a biphenyl group and a fluorene group.

Commercially available products of an epoxy resin having a naphthalene skeleton may be used, as exemplified by HP4032D (melting point of 80° C.) of Dainippon Ink and Chemicals, Inc.

As the aromatic amine-based curing agent used in the present invention may be used an aromatic amine which is used as an epoxy resin curing agent without particular restriction. Examples of the aromatic amine-based curing agent include diaminodiphenylsulfone (DDS) represented by the following formula (3), diaminodiphenylmethane (DDM), diaminodiphenyl ether (DADPE), bisaniline and benzyldimethylaniline.

They may be used alone or in combination of two or more.

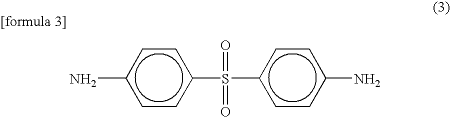

Out of these aromatic amine-based curing agents, an aromatic amine-based compound having two or more amino groups in the molecule is preferred because the compound has excellent heat resistance. Examples of the aromatic amine-based compound include diaminodiphenylsulfone (DDS), diaminodiphenylmethane (DDM) and diaminodiphenyl ether (DADPE). Isomers of diaminodiphenylsulfone (DDS) are preferably used because the isomers offer obtain excellent heat resistance.

The prepreg resin composition obtained by the process of the present invention is impregnated into a reinforcing fiber to produce a prepreg. A hot melt method may be used for impregnation.

To produce a prepreg by a wet method, the prepreg resin composition obtained as described above is dissolved in a solvent to prepare varnish followed by impregnation into a reinforcing fiber. The solvent used for the preparation of varnish is preferably a ketone such as methyl ethyl ketone (MEK). The amount of the solvent used is preferably 1 to 20 parts by weight based on 100 parts by weight of the prepreg resin composition to optimize the drying step.

The reinforcing fiber to be impregnated includes fibrous woven fabric such as carbon fiber, aramide fiber such as Kevler®, glass fiber, unidirectional fiber thereof (long fiber), or the like. Specific examples of the reinforcing fiber include the Carbon Fiber T-300 and T-700 of Toray Industries, Inc. and the Carbon Fiber HTA grade of Toho Rayon Co., Ltd. The weight of the fiber is preferably 140 to 200 g/m².

The prepreg can be produced by using an apparatus such as a unidirectional (UD) machine. Since the weight of the reinforcing material greatly differs according to the material and weave structure of the fiber, the impregnation rate of the rein composition may be adjusted according to application purpose.

A prepreg composed of the prepreg resin composition produced by the process of the present invention has toughness because the solid rubber component is uniformly dispersed in the epoxy resin and is free from a void because the prepreg has no low-volatile component such as a solvent. Therefore, a stable prepreg resin composition can be obtained.

The prepreg resin composition obtained by the process of the present invention is a matrix resin for a prepreg and may serve as an adhesive for a honeycomb. Therefore, there is no need of using an adhesive sheet between the honeycomb and the prepreg, thereby making it easy to produce a structure composed of the honeycomb and prepreg. Also the amounts of subsidiary materials used such as an adhesive sheet and release paper can be reduced, thereby contributing to the preservation of the global environment.

The honeycomb may be made from any material if the material is non-metal, such as resin or paper. For example, a Nomex honeycomb prepared by impregnating Nomex with a phenolic resin is the most preferred in view of its application to airplanes. The size of the hexagonal pillar of a honeycomb structure is not limited but the length of a honeycomb cell is preferably ⅛ to ⅜ inch from the viewpoints of strength and weight reduction.

The prepreg resin composition obtained by the process of the present invention has such co-curability that the curing of a prepreg itself and the adhesion to a honeycomb can be carried out at the same time. For the bonding method, for example, a prepreg impregnated with the prepreg resin composition is bonded to one or both end faces of the honeycomb and thermally cured in an autoclave or the like while pressure is applied from both ends.

The curing conditions for bonding the honeycomb to the prepreg include 2 to 5° C./min and a pressure of 2.5 to 4.0 kg/cm². After the temperature is raised to 150 to 185° C., they are left at 150 to 185° C. for 1 to 2 hours and then cooled to room temperature at a rate of 2 to 5° C./min.

Since the thus obtained structure composed of the prepreg and the honeycomb has excellent heat resistance and is satisfactory in terms of adhesion between the prepreg and the honeycomb, the structure is suitable for use as a structural material for airplanes, automobiles, and the like.

### EXAMPLES

The following examples are provided for the purpose of further illustrating the present invention but are in no way to be taken as limiting. When there was no definite softening point, the temperature at which the viscosity is lowered to less than about 1000 P was regarded as the softening point.

### Example 1

1 kg of solid acrylonitrile butadiene rubber A (Nipol®1072 of Nippon Zeon Co., Ltd.) and 3 kg of a solid epoxy resin A (HP7200 of Dainippon Ink and Chemicals, Inc.) were mixed together at room temperature by two rolls (while the two rolls were cooled to prevent the temperature increase). Mixing was stopped when the pre-mixture was rolled thin and the solid rubber particles were not seen with the eyes.

5 kg of a liquid epoxy resin A (ELM®434 of Sumitomo Chemical Co., Ltd.; softening point of 30° C.) and 2 kg of a liquid epoxy resin B (YD-128 of Toto Kasei Co., Ltd.; softening point of about 5° C.) were added to 4 kg of the obtained pre-mixture and further 0.7 equivalent of an aromatic amine-based curing agent A (4,4′-diaminodiphenylsulfone, Seikacure S of Wakayama Seikasha Co., Ltd.) based on the epoxy groups was added thereto and mixed by a trimixer (Trimix® of Inoue Seisakusho Co., Ltd.).

The solid rubber particles were not seen in the obtained mixture.

### Example 2

4 kg of the pre-mixture obtained in Example 1 was formed into a pellet having a length of about 4 mm, 5 kg of the liquid epoxy resin A and 2 kg of the liquid epoxy resin B were added to this pellet by a continuous kneader (Continuous Kneader of Kurimoto Ltd.), and further 1.0 equivalent of an aromatic amine-based curing agent B (3,3′-diaminodiphenylsulfone) based on the epoxy groups was added thereto and mixed continuously.

The solid rubber particles were not seen in the mixture.

### Example 3

1 kg of solid acrylonitrile butadiene rubber B (Nipol®DN631 of Nippon Zeon Co., Ltd.) and 2 kg of a solid epoxy resin B (HP4032D of Dainippon Ink and Chemicals, Inc., melting point of 80° C.) were mixed together at room temperature by a kneader (M-5 of Moriyama Company Ltd.) (while being cooled to keep the temperature).

4 kg of the liquid epoxy resin A, 2 kg of the liquid epoxy resin B and 1 kg of a liquid epoxy resin C (ELM100 of Sumitomo Chemical Co., Ltd.; softening point of −25° C.) were added to 3 kg of the pre-mixture and further 1.0 equivalent of an aromatic amine-based curing agent C (compound name: diaminodiphenylmethane) based on the epoxy groups was added thereto and mixed by a trimixer (the same as above).

The solid rubber particles were not seen in the obtained mixture.

### Comparative Example 1

3 kg of a solid epoxy resin A, 5 kg of the liquid epoxy resin A and 2 kg of the liquid epoxy resin B were added to 1 kg of solid acrylonitrile butadiene rubber (Nipol®1041 of Nippon Zeon Co., Ltd.), and further 0.7 equivalent of the aromatic amine-based curing agent A (4,4′-diaminodiphenylsulfone, Seikacure S of Wakayama Seikasha Co., Ltd.) based on the epoxy groups was added thereto and mixed together by a kneader (the same as above). 1 mm-diameter solid rubber particles were seen in the mixture.

### Comparative Example 2

2 kg of the solid epoxy resin B, 4 kg of the liquid epoxy resin A, 2 kg of the liquid epoxy resin B and 1 kg of the liquid epoxy resin C were added to 1 kg of solid acrylonitrile butadiene rubber (Nipol®1001), and further 1.0 equivalent of the aromatic amine-based curing agent E (compound name: 3,3′-diaminodiphenylsulfone) based on the epoxy groups was added thereto and mixed together by a trimixer (the same as above).

1.5 mm-diameter solid rubber particles were seen in the mixture.

### Comparative Example 3

1 kg of the liquid epoxy resin B was added to 1 kg of solid acrylonitrile butadiene rubber A and mixed together by a kneader (the same as above).

3 kg of the solid epoxy resin A, 5 kg of the liquid epoxy resin A and 1 kg of the liquid epoxy resin B were added to 2 kg of the obtained pre-mixture, and further 1.0 equivalent of an aromatic amine-based curing agent F (diaminodiphenylmethane) based on the epoxy groups was added thereto and mixed together by a trimixer (the same as above). Since the mixture was stuck to the corners of the mixer, the mixture could not be partly mixed.

### Example 4

Carbon fiber T-300 12K of Toray Industries, Inc. was impregnated with the mixture obtained in Example 1 so that the resin content may be 40 wt %, thereby preparing a prepreg. The prepreg was then adhered to an aramide based honeycomb core of Showa Aircraft Industry Co., Ltd. (type SAH—⅛ in.—8.0, 12.7 mm in thickness) to obtain a honeycomb structure having co-curability and excellent heat resistance.

According to the process of the present invention, since the solid rubber and the solid epoxy resin are mixed together under shearing stress, the rubber component can be uniformly dispersed into the epoxy resin under a normal working atmosphere in a short period of time without using a solvent.

Since a mixture of the solid rubber and the solid epoxy resin can be palletized, a continuous mixer such as a double-screw mixer or continuous kneader can be used.

What is claimed is:

1. A process for producing a prepreg resin composition, comprising:
mixing 100 parts by weight of solid acrylonitrile butadiene rubber with 50 to 400 parts by weight of a solid epoxy resin having a melting point or softening point of 40° C. or higher at a temperature lower than the melting point or softening point of the solid epoxy resin in the absence of a solvent to form a pre-mixture; and
mixing the pre-mixture with 500 to 7,000 parts by weight of a liquid epoxy resin having a melting point or softening point of lower than 40° C. and 0.6 to 1.1 equivalents of an aromatic amine-based curing agent based on the epoxy groups which belong to the solid epoxy resin and the liquid epoxy resin.

2. The process for producing a prepreg resin composition according to claim 1, wherein the solid epoxy resin has at least one functional group selected from the group consisting of a naphthalene ring, a dicyclopentadienyl group, a bisphenyl group and a fluorene group.
